(19) United States
(12) Patent Application Publication
(10) Pub. No.: US 2026/0027511 A1
(43) Pub. Date: Jan. 29, 2026

(54) REBOILER AND ACID GAS RECOVERY SYSTEM

(71) Applicant: MITSUBISHI HEAVY INDUSTRIES, LTD., Tokyo (JP)

(72) Inventors: Masaki Onishi, Tokyo (JP); Tatsuya Tsujiuchi, Tokyo (JP); Osamu Miyamoto, Tokyo (JP); Yoshiyuki Kondo, Tokyo (JP); Takashi Sato, Tokyo (JP)

(73) Assignee: MITSUBISHI HEAVY INDUSTRIES, LTD., Tokyo (JP)

(21) Appl. No.: 18/783,524

(22) Filed: Jul. 25, 2024

(51) Int. Cl. B01D 53/14; B01D 53/18; B01D 53/62; B01D 53/78; B01D 53/96; F28F 13/12

(52) U.S. Cl. CPC B01D 53/1425; B01D 53/1475; B01D 53/1493; B01D 53/18; B01D 53/62; B01D 53/78; B01D 53/96; F28F 13/12; B01D 2252/20478; B01D 2257/504; B01D 2258/06

(57) ABSTRACT

A reboiler includes a casing vertical extending and to which a heat medium raised a temperature of an absorption liquid is supplied, a heat transfer tube vertical extending inside the casing to pass through the heat medium space and through which the absorption liquid is flowable, and a heat transfer enhancement device disposed inside the heat transfer tube, vertical extending, and generating turbulence in the flowing absorption liquid. The heat transfer tube has a lower end inlet at a lower end in the vertical direction, through which the absorption liquid in a liquid phase state is introduced, and an upper end outlet at an upper end in the vertical direction, through which the absorption liquid in a gas-liquid two-phase state is discharged. The heat transfer enhancement device extends upward from the lower end inlet to a position spaced downward from the upper end outlet in the vertical direction.

### BACKGROUND OF THE INVENTION

### Field of the Invention

The present disclosure relates to a reboiler and an acid gas recovery system.

### Description of Related Art

In recent years, from the viewpoint of carbon neutrality, attention has been focused on the concentration of carbon dioxide (CO₂) in the atmosphere. From the viewpoint of reducing the concentration of carbon dioxide in the atmosphere, a carbon dioxide recovery system that recovers carbon dioxide from an exhaust gas is known. In a carbon dioxide recovery system, an absorption liquid is circulated between a regeneration tower and an absorption tower to recover carbon dioxide from an exhaust gas.

For example, Patent Document 1 discloses a carbon dioxide recovery device (CO₂ recovery device) that uses an absorption liquid that absorbs carbon dioxide to remove carbon dioxide from a gas in an absorption liquid absorption tower and regenerates the absorption liquid in an absorption liquid regeneration tower. In the absorption liquid regeneration tower, the absorption liquid is regenerated by releasing carbon dioxide from a rich solution, which is the absorption liquid that has absorbed carbon dioxide. In the absorption liquid regeneration tower, a part of a lean liquid, which is the absorption liquid from which carbon dioxide has been released, is supplied to a reboiler. In the reboiler, the lean liquid supplied thereto is heated by heat exchange between the lean liquid and steam, and the heated lean liquid and steam are supplied into the absorption liquid regeneration tower.

### CITATION LIST

### Patent Document

[Patent Document 1] Japanese Unexamined Patent Application, First Publication No. 2022-180026

### SUMMARY OF THE INVENTION

In the above-mentioned carbon dioxide recovery device, the reboiler heats a multi-component liquid having different boiling points that contains an amine compound, such as the absorption liquid. In such a multi-component liquid, the composition ratio may change from moment to moment depending on the operating conditions of the absorption tower and the regeneration tower. When the composition ratio changes, the flow state, including the boiling point, will change when heating in the reboiler, making it difficult to heat under stable conditions. Therefore, it is desired to improve the heating efficiency by the reboiler even for the absorption liquid whose composition ratio changes in this way. At the same time, in the boiling flow inside the tube, some kind of disturbance may cause flow instabilities. When flow instabilities occurs, the flow rate and amount of heat will become unstable, which may cause the operating state of the carbon dioxide recovery device to become unstable.

The present disclosure has been made to solve the above-mentioned demand, and an object of the present disclosure is to provide a reboiler and an acid gas recovery system capable of improving the heating efficiency of an absorption liquid by the reboiler.

In order to solve the above problems, according to one aspect of the present disclosure, there is provided a reboiler that heats an absorption liquid containing water and an amine supplied from an acid gas recovery device, the reboiler including: a casing extending in a vertical direction and forming a heat medium space therein to which a heat medium, which configured to raise a temperature of the absorption liquid is supplied; a heat transfer tube extending in the vertical direction, disposed inside the casing to pass through the heat medium space, and through which the absorption liquid is flowable; and a heat transfer enhancement device disposed inside the heat transfer tube, extending in the vertical direction, and generating turbulence in the flowing absorption liquid through the heat transfer tube, in which the heat transfer tube has a lower end inlet which is a lower end of the heat transfer tube in the vertical direction and through which the absorption liquid in a liquid phase state is introduced, and an upper end outlet which is an upper end of the heat transfer tube in the vertical direction and through which the absorption liquid in a gas-liquid two-phase state is discharged, and the heat transfer enhancement device extends upward from the lower end inlet to a position spaced downward from the upper end outlet in the vertical direction.

In addition, according to another aspect of the present disclosure, there is provided an acid gas recovery system including: an absorption tower that brings a target gas of treatment containing an acid gas into contact with an absorption liquid containing water and an amine and discharges the absorption liquid having absorbed the acid gas and an absorption tower exhaust gas containing the target gas of treatment from which the acid gas has been removed; a regeneration tower that dissipates the acid gas from the absorption liquid discharged from the absorption tower and discharges the absorption liquid from which the acid gas has been dissipated and a regeneration tower exhaust gas containing the acid gas; and the reboiler, in which the reboiler is supplied with the absorption liquid in the regeneration tower, which is the acid gas recovery device.

According to the reboiler and acid gas recovery system of the present disclosure, the heating efficiency of the absorption liquid by the reboiler can be improved.

### BRIEF DESCRIPTION OF THE DRAWINGS

FIG. 1 is a schematic diagram showing a carbon dioxide recovery system according to the present embodiment.

FIG. 2 is a schematic diagram showing a relationship between a regeneration tower and a reboiler according to the present embodiment.

FIG. 3 is a schematic diagram showing a heat transfer tube according to a first embodiment.

FIG. 4 is a schematic diagram showing a heat transfer tube according to a second embodiment.

FIG. 5 is a schematic diagram showing a heat transfer tube according to a third embodiment.

FIG. 6 is a schematic diagram showing a first modification example of a first turbulence structure portion.

FIG. 7 is a schematic diagram showing a second modification example of the first turbulence structure portion.

FIG. 8 is a schematic diagram showing a first modification example of a connecting portion.

FIG. 9 is a schematic diagram showing a first modification example of the connecting portion.

### DETAILED DESCRIPTION OF THE INVENTION

Hereinafter, an embodiment of an acid gas recovery system according to the present disclosure will be described with reference to the accompanying drawings. However, the present disclosure is not limited to only the embodiment.

### First Embodiment

### Carbon Dioxide Recovery System

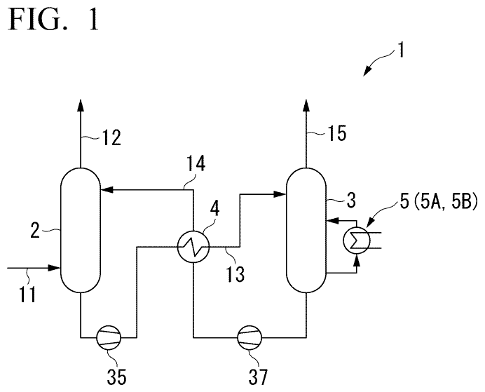

A carbon dioxide recovery system 1 (acid gas recovery system) is a facility that processes a target gas of treatment from a gas generation source (not shown) to recover an acid gas. As shown in FIG. 1, a carbon dioxide recovery system 1 according to the present embodiment is capable of separating and recovering carbon dioxide contained in a target gas of treatment using an absorption liquid, and supplying the recovered carbon dioxide to another device. Gas generation sources include, for example, waste incinerators, coal or natural gas fired power plants, gas turbines, gas engines, cement plants, steel plants, glass melting plants, ethanol production plants, and the like. The target gas of treatment from this gas generation source contains the gas to be recovered, ash, heavy metals, hydrocarbons, and the like. The gases to be recovered include, in addition to carbon dioxide (CO2), nitrogen oxides (NOx) such as nitric oxide (NO), sulfur oxides (SOx) such as sulfur dioxide (SO2), and acid gases such as hydrogen sulfide (H2S). In the present embodiment, carbon dioxide will be described as an example of the gas to be recovered. The gas generation source may also be a facility outside the carbon dioxide recovery system 1 that supplies atmospheric air to the carbon dioxide recovery system 1. In other words, the carbon dioxide recovery system 1 treats exhaust gases discharged from various facilities and the atmosphere as gases to be treated.

The absorption liquid is preferably one that has a high acid gas absorption rate and requires low regeneration energy. The absorption liquid contains water and an amine. The absorption liquid is a multi-component aqueous solution containing compounds with different boiling points. For example, in a case where carbon dioxide is absorbed, the absorption liquid may be an aqueous amine solution or a non-aqueous amine liquid in which a physical absorption solvent is applied instead of water. As the amine absorption liquid, specifically, for example, alkanolamines such as monoethanolamine (MEA), diethanolamine (DEA), triethanolamine (TEA), methyldiethanolamine (MDEA), diisopropanolamine (DIPA), and diglycolamine (DGA) can be employed. Hindered amines can also be employed. Furthermore, each of these aqueous solutions alone or two or more mixed aqueous solutions thereof can also be employed.

As shown in FIG. 1, the carbon dioxide recovery system 1 according to the present embodiment includes an absorption tower 2, a target gas of treatment line 11, a regeneration tower 3, a rich line 13, a lean line 14, an absorption liquid heat exchanger 4, a regeneration tower discharge line 15, and a reboiler 5.

The target gas of treatment is introduced into the absorption tower 2 through the target gas of treatment line 11. The target gas of treatment line 11 sends the target gas of treatment sent from the exhaust gas generation source to the absorption tower 2 after cooling the target gas of treatment in a cooling device (not shown). The target gas of treatment line 11 is connected to the absorption tower 2.

The absorption tower discharge line 12 is connected to the top of the absorption tower 2 and discharges an absorption tower exhaust gas discharged from the absorption tower 2 to the outside.

The regeneration tower 3 causes carbon dioxide to dissipate from the absorption liquid discharged from the absorption tower 2. The regeneration tower 3 supplies the absorption liquid to the reboiler 5 for heating. Accordingly, in the regeneration tower 3, most of the carbon dioxide is dissipated from the absorption liquid together with the steam, and the carbon dioxide is separated from the absorption liquid. The regeneration tower 3 separately discharges the absorption liquid from which carbon dioxide has been dissipated and a regeneration tower exhaust gas mainly composed of carbon dioxide.

The rich line 13 supplies the absorption liquid that has absorbed carbon dioxide from the absorption tower 2 to the regeneration tower 3. Here, the absorption liquid discharged from the absorption tower 2 and flowing through the rich line 13 is referred to as a rich liquid. The rich liquid is an absorption liquid having a high concentration of carbon dioxide after absorbing carbon dioxide in the absorption tower 2. The rich line 13 connects the bottom of the absorption tower 2 to the top of the regeneration tower 3. A rich pump 35 is disposed in the rich line 13. The rich pump 35 pressurizes the rich liquid and sends it to the regeneration tower 3 via the absorption liquid heat exchanger 4.

The lean line 14 supplies the absorption liquid from which carbon dioxide has been dissipated from the regeneration tower 3 to the absorption tower 2. Here, the absorption liquid discharged from the regeneration tower 3 and flowing through the lean line 14 is referred to as a lean liquid. The lean liquid is an absorption liquid having a low concentration of carbon dioxide after the carbon dioxide is dissipated in the regeneration tower 3. In other words, the lean liquid has a lower carbon dioxide concentration than the rich liquid. The lean line 14 connects the bottom of the regeneration tower 3 to the top of the absorption tower 2. A lean pump 37 is disposed in the lean line 14. The lean pump 37 pressurizes the lean liquid and sends it to the absorption tower 2 via the absorption liquid heat exchanger 4.

The absorption liquid heat exchanger 4 exchanges heat between the rich liquid flowing through the rich line 13 and the lean liquid flowing through the lean line 14. Accordingly, in the absorption liquid heat exchanger 4, the absorption liquid flowing through the rich line 13 in a state where the absorption liquid has been pressurized by the rich pump 35 to flow from the absorption tower 2 to the regeneration tower 3 is heated. In addition, in the absorption liquid heat exchanger 4, the absorption liquid flowing through the lean line 14 in a state where the absorption liquid has been pressurized by the lean pump 37 to flow from the regeneration tower 3 to the absorption tower 2 is cooled.

The regeneration tower discharge line 15 discharges the regeneration tower exhaust gas discharged from the regeneration tower 3 to the outside of the carbon dioxide recovery system 1 (outside the system). The regeneration tower discharge line 15 is connected to the top of the regeneration tower 3. The regeneration tower discharge line 15 transfers the regeneration tower exhaust gas to an external destination according to the purpose of use. The regeneration tower exhaust gas, which is mainly composed of carbon dioxide and is discharged from the regeneration tower discharge line 15, is compressed or liquefied according to the purpose of use, and is stored in a tank or used via a pipeline to be stored inside an oil field or in an aquifer.

### Reboiler

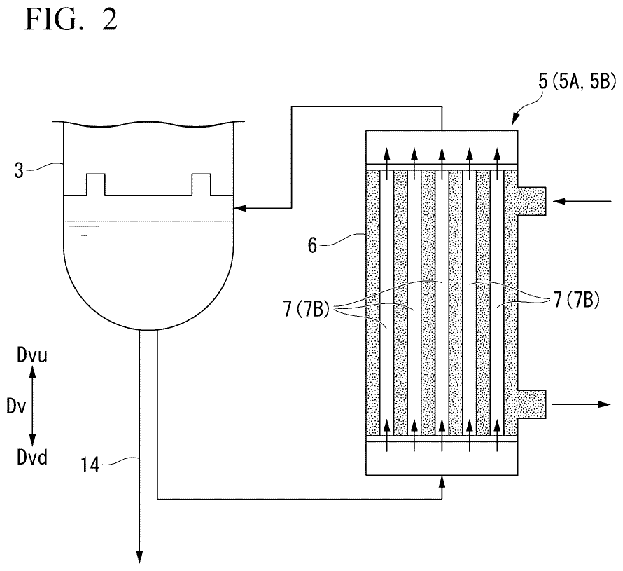

The reboiler 5 heats the absorption liquid containing water and an amine, which is supplied from the regeneration tower 3, which is an acid gas recovery device. As shown in FIG. 2, a part of the lean liquid stored in the regeneration tower 3 before being discharged is supplied to the reboiler 5. That is, the absorption liquid containing carbon dioxide in addition to water and an amine is supplied to the reboiler 5 as an object to be heated. Furthermore, high-temperature steam is supplied to the reboiler 5 from outside the system. In the reboiler 5, heat exchange is carried out between the supplied steam and the absorption liquid, thereby heating the absorption liquid. The reboiler 5 according to the present embodiment includes a casing 6, a plurality of heat transfer tubes 7, and a plurality of heat transfer enhancement devices 8.

The casing 6 forms therein a heat medium space to which a heat medium capable of raising the temperature of the absorption liquid is supplied. That is, the casing 6 is formed to be hollow. The casing 6 extends in a vertical direction Dv. Specifically, the casing 6 is formed in a cylindrical shape with a bottom that extends in the vertical direction Dv. In addition, high-temperature steam is supplied to the casing 6 as a heat medium. The casing 6 is formed with an inlet nozzle for introducing steam and an outlet nozzle for discharging steam. The inlet nozzle and the outlet nozzle are disposed at intervals in the vertical direction Dv.

The plurality of heat transfer tubes 7 are disposed inside the casing 6 to pass through the heat medium space. The plurality of heat transfer tubes 7 extend in the vertical direction Dv inside the casing 6. Each of the plurality of heat transfer tubes is configured such that the absorption liquid can flow therethrough. The steam flowing through the heat medium space exchanges heat with the absorption liquid flowing inside the plurality of heat transfer tubes 7, whereby the absorption liquid is heated. The plurality of heat transfer tubes 7 are disposed at intervals in a direction orthogonal to the vertical direction Dv.

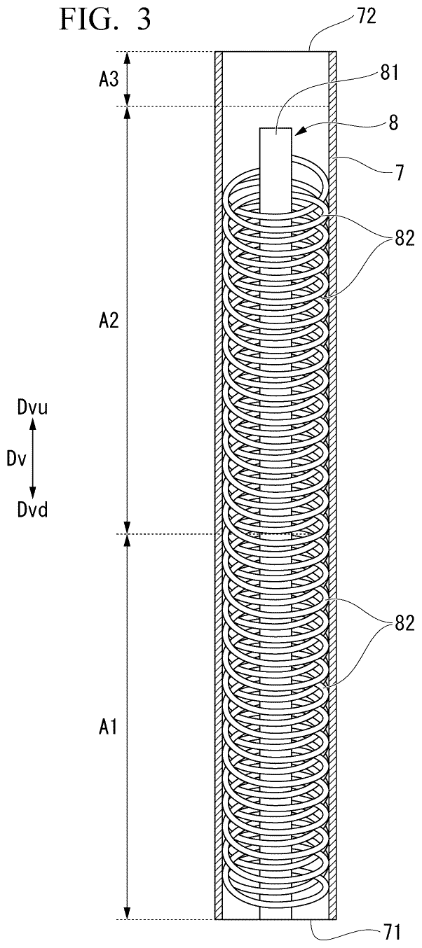

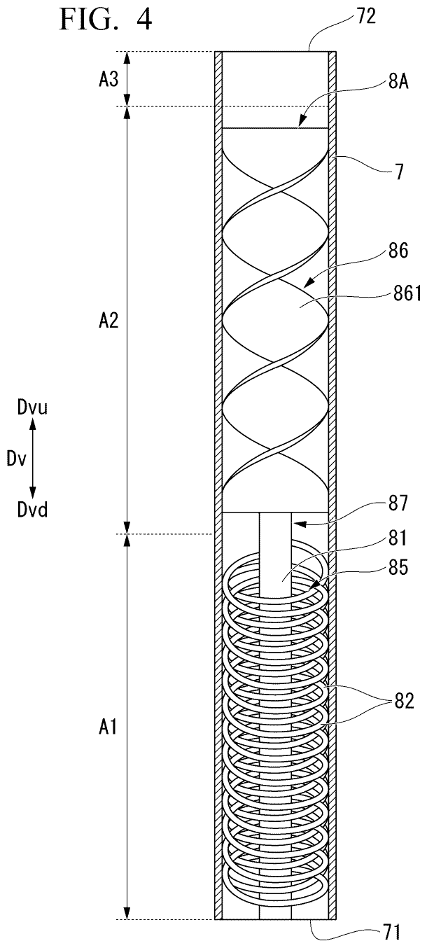

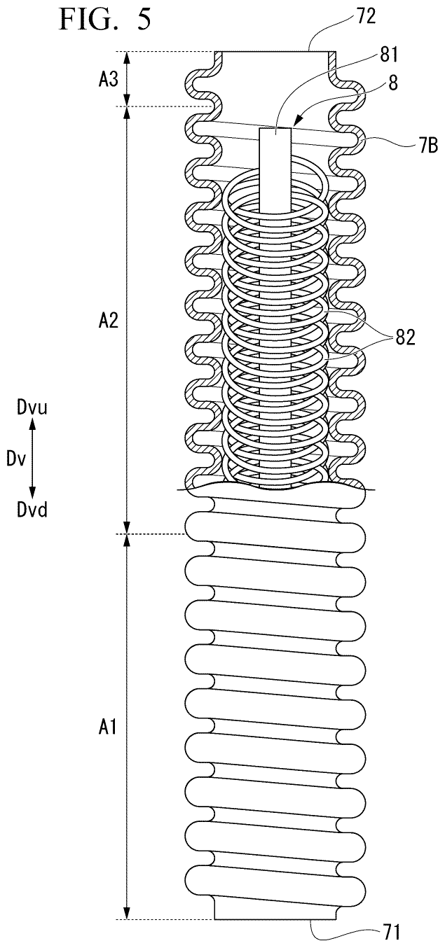

Each of the heat transfer tubes 7 is formed in a hollow cylindrical shape. Each heat transfer tube 7 extends straight in the vertical direction Dv. As shown in FIG. 3, each heat transfer tube 7 has a lower end inlet 71 and an upper end outlet 72. The lower end inlet 71 is the lower end of the heat transfer tube 7 in the vertical direction Dv. The lower end inlet 71 is adapted to introduce the absorption liquid in a liquid phase state. The upper end outlet 72 is the upper end of the heat transfer tube 7 in the vertical direction Dv. The absorption liquid in a gas-liquid two-phase state is discharged from the upper end outlet 72. That is, in the heat transfer tube 7, the absorption liquid in a liquid phase state flows in from the lower end inlet 71, is heated and changes state, and the absorption liquid in a gas-liquid two-phase state is discharged from the upper end outlet 72.

The space inside the heat transfer tube 7 forms a preheating region A1, a bubble flow region A2, and a gas-liquid multiphase flow region A3.

The preheating region A1 is a region capable of preheating the absorption liquid. Specifically, in the preheating region A1, the absorption liquid is heated from a liquid state to a state in which no phase change occurs. That is, in the preheating region A1, the absorption liquid flows in a single-phase state of only the liquid phase (single-phase flow). The preheating region A1 is formed at a position facing the lower end inlet 71.

The bubble flow region A2 is a region where bubbles are generated by vaporizing a part of the absorption liquid. In the bubble flow region A2, a small amount of bubbles are present in the absorption liquid in the liquid state. That is, in the bubble flow region A2, the liquid phase contains a small amount of gas phase. The bubble flow region A2 is located at an upward position Dvu in the vertical direction Dv with respect to the preheating region A1. The bubble flow region A2 is connected to the preheating region A1.

The gas-liquid multiphase flow region A3 is a region where a gas-liquid interface is violently disturbed and a flow in a state where the gas and liquid are mixed together is generated. The gas-liquid multiphase flow region A3 is formed at a position facing the upper end outlet 72. The gas-liquid multiphase flow region A3 is connected to the bubble flow region A2. Therefore, in the vertical direction Dv, the space inside the heat transfer tube 7 is formed, in order, with the preheating region A1 in contact with the lower end inlet 71, the bubble flow region A2, and the gas-liquid multiphase flow region A3 in contact with the upper end outlet 72.

The heat transfer enhancement device 8 generates turbulence in the flowing absorption liquid. The heat transfer enhancement device 8 can change the structure of the flow field of the absorption liquid flowing inside the heat transfer tube 7, thereby promoting heat transfer. The heat transfer enhancement device 8 is disposed inside the heat transfer tube 7. The heat transfer enhancement devices 8 are disposed inside all the heat transfer tubes 7. The heat transfer enhancement devices 8 extend in the vertical direction Dv. The heat transfer enhancement device 8 extends upward Dvu from the lower end inlet 71 to a position spaced downward Dvd from the upper end outlet 72 in the vertical direction Dv. In other words, the heat transfer enhancement device 8 is disposed facing the lower end inlet 71 while being spaced apart from the upper end outlet 72. The heat transfer enhancement device 8A extends to be disposed only in the preheating region A1 and the bubble flow region A2 among the preheating region A1, the bubble flow region A2, and the gas-liquid multiphase flow region A3. In other words, the heat transfer enhancement device 8 is disposed inside the heat transfer tube 7 not to be disposed in the gas-liquid multiphase flow region A3. The heat transfer enhancement device 8 preferably extends to a transition zone formed between the bubble flow region A2 and the gas-liquid multiphase flow region A3. The heat transfer enhancement device 8 of the present embodiment includes a shaft core portion 81 and a turbulence forming portion 82.

The shaft core portion 81 is formed in a rod shape extending in the vertical direction Dv. The shaft core portion 81 is formed with an axial diameter that does not disturb the flow of the absorption liquid flowing inside heat transfer tubes 7 and 7B. The shaft core portion 81 extends straight in the vertical direction Dv. The shaft core portion 81 extends from the lower end inlet 71 through the preheating region A1 to the bubble flow region A2.

The turbulence forming portion 82 protrudes from the shaft core portion 81 toward an inner peripheral surface of the heat transfer tube 7. The turbulence forming portion 82 is disposed to fill a space between an outer peripheral surface of the shaft core portion 81 and the inner peripheral surface of the heat transfer tube 7. The turbulence forming portion 82 is formed by randomly disposing a plurality of wire-like members, each of which is spirally formed on the outer peripheral surface of the shaft core portion 81, with no gaps therebetween. Adjacent turbulence forming portions 82 are disposed to at least partially overlap each other when viewed from the vertical direction Dv. The plurality of turbulence forming portions 82 are disposed three-dimensionally inside the heat transfer tube 7 to be interwoven with each other. The turbulence forming portion 82 is disposed from the lower end inlet 71 to the preheating region A1 and the bubble flow region A2. Accordingly, the plurality of turbulence forming portions 82 sufficiently fill the space between the outer peripheral surface of the shaft core portion 81 and the inner peripheral surface of the heat transfer tube 7 while forming gaps.

### Operation and Effect

In the reboiler 5 having the above-described configuration, heat exchange occurs between high-temperature steam supplied to the heat medium space inside the casing 6 and the absorption liquid flowing inside the plurality of heat transfer tubes 7, thereby heating the absorption liquid. Inside the heat transfer tubes 7, the absorption liquid flowing in from the lower end inlet 71 comes into contact with the heat transfer enhancement devices 8 and generates turbulence, while flowing toward the upper end outlet 72. The heat transfer enhancement devices 8 generate turbulence in the absorption liquid, thereby promoting heat transfer and improving the heating efficiency of the absorption liquid. In particular, by extending the heat transfer enhancement devices 8 from the lower end inlet 71, the pressure loss occurring in the absorption liquid that has just flowed into the heat transfer tubes 7 can be increased. This allows the absorption liquid flowing in from the lower end inlet 71 to be agitated and uniformly supplied toward the upper end outlet 72. Furthermore, the heat transfer enhancement devices 8 extend in the vertical direction Dv from the lower end inlet 71 to a position spaced downward Dvd from the upper end outlet 72 through which the absorption liquid in a gas-liquid two-phase state is discharged. At the upper end outlet 72 from which the absorption liquid in a gas-liquid two-phase state is discharged, large bubbles are present. If large bubbles come into contact with the heat transfer enhancement devices 8, the increase in heat transfer performance relative to an increase in pressure loss is reduced. However, the heat transfer enhancement devices 8 are located away from the upper end outlet 72 where the absorption liquid in a gas-liquid two-phase state containing large bubbles is present. As a result, the pressure loss caused by the heat transfer enhancement devices 8 can be suppressed, and the heat transfer performance can be further improved. Accordingly, it is possible to improve the heating efficiency of the absorption liquid by the reboiler 5.

In addition, the heat transfer enhancement devices 8 extend to be disposed only in the preheating region A1 and the bubble flow region A2 among the preheating region A1, the bubble flow region A2, and the gas-liquid multiphase flow region A3. In other words, the heat transfer enhancement devices 8 are not disposed in the gas-liquid multiphase flow region A3 inside the heat transfer tube 7 where large bubbles are present and the proportion of gas phase is the highest. By disposing the heat transfer enhancement devices 8 inside the heat transfer tubes 7, avoiding the gas-liquid multiphase flow region A3 which has the highest gas phase proportion, it is possible to precisely reduce pressure loss due to the heat transfer enhancement devices 8 while further improving heat transfer performance. Accordingly, it is possible to improve the heating efficiency of the absorption liquid by the reboiler 5 with high precision.

In addition, the absorption liquid continues to circulate for a long period of time by operating the carbon dioxide recovery system 1 for a long period of time. Therefore, various impurities are mixed into the absorption liquid. As a result, the viscosity of the absorption liquid increases, and the heat transfer performance inside the heat transfer tube 7 decreases. However, since the heat transfer enhancement device 8 is disposed inside the heat transfer tube 7 through which the absorption liquid flows, the flow of the absorption liquid inside the heat transfer tube 7 is disturbed. Therefore, even if the absorption liquid with a high viscosity is caused to flow, clogging of the heat transfer tubes 7 can be suppressed. Therefore, the heating efficiency of the absorption liquid by the reboiler 5 can be maintained at a high level for a long period of time.

In addition, such a reboiler 5 heats the lean liquid supplied from the regeneration tower 3. Therefore, the absorption liquid circulating between the regeneration tower 3 and the absorption tower 2 can be efficiently heated to dissipate carbon dioxide.

### Second Embodiment

Next, a reboiler 5A according to a second embodiment of the present disclosure will be described. In the second embodiment described below, configurations common to the first embodiment are given the same reference numerals in the drawings and descriptions thereof will be omitted. In the second embodiment, the structure of a heat transfer enhancement device 8A in the reboiler 5A is different from the structure in the first embodiment.

In the reboiler 5A of the second embodiment, the heat transfer enhancement device 8A has a different structure in the vertical direction Dv. Specifically, the heat transfer enhancement device 8A of the second embodiment includes a first turbulence structure portion 85, a second turbulence structure portion 86, and a connecting portion 87.

The first turbulence structure portion 85 changes the flow of the absorption liquid into a turbulent state. The first turbulence structure portion 85 has the same structure as the heat transfer enhancement device 8A of the first embodiment, except for its length in the vertical direction Dv. The first turbulence structure portion 85 is disposed facing the lower end inlet 71.

The second turbulence structure portion 86 is formed in a shape different from a shape of the first turbulence structure portion 85 to change the flow of the absorption liquid into a turbulent state different from a turbulent state of the first turbulence structure portion 85. The second turbulence structure portion 86 is disposed at the upward position Dvu in the vertical direction Dv with respect to the first turbulence structure portion 85. The second turbulence structure portion 86 is disposed with a gap in the vertical direction Dv from the first turbulence structure portion 85. The second turbulence structure portion 86 is disposed spaced apart from the upper end outlet 72. The second turbulence structure portion 86 includes a spiral plate portion 861 that formed by twisting in a spiral shape to generate a swirling flow in the absorption liquid. When viewed from the vertical direction Dv, the spiral plate portion 861 is formed in a spiral shape with the center of the heat transfer tube 7 as the base point. The spiral plate portion 861 is twisted from a downward position Dvd to an upward position Dvu in the vertical direction Dv. The spiral plate portion 861 is formed to have a size that allows it to come into sliding contact with the inner peripheral surface of the heat transfer tube 7.

The connecting portion 87 connects the first turbulence structure portion 85 and the second turbulence structure portion 86 in the vertical direction Dv. The connecting portion 87 is formed in a rod shape extending in the vertical direction Dv. The connecting portion 87 is formed with an axial diameter that does not disturb the flow of the absorption liquid flowing inside the heat transfer tube 7. The connecting portion 87 is formed to have the same diameter as the shaft core portion 81. In the vertical direction Dv, the lower end of the connecting portion 87 is connected to the upper end of the first turbulence structure portion 85. In other words, the connecting portion 87 is formed by extending the shaft core portion 81 of the first turbulence structure portion 85 upward Dvu in the vertical direction Dv. In the vertical direction Dv, the upper end of the connecting portion 87 is connected to the lower end of the second turbulence structure portion 86.

### Operation and Effect

In the reboiler 5A of the second embodiment, the heat transfer enhancement device 8A includes the first turbulence structure portion 85 that changes the flow of the absorption liquid to a turbulent state, and the second turbulence structure portion 86 that is formed in a shape different from that of the first turbulence structure portion 85 to change the flow of the absorption liquid to a turbulent state different from that of the first turbulence structure portion 85. In addition, the second turbulence structure portion 86 is disposed at the upward position Dvu in the vertical direction Dv with respect to the first turbulence structure portion 85. Therefore, inside the heat transfer tubes 7, the absorption liquid flows to reach the second turbulence structure portion 86 after the flow is disturbed in the first turbulence structure portion 85. Accordingly, in the region close to the lower end inlet 71, the flow is disturbed by the first turbulence structure portion 85, and in the region close to the upper end outlet 72, the flow is disturbed by the second turbulence structure portion 86. Therefore, even if the state of the absorption liquid differs between the region close to the lower end inlet 71 and the region close to the upper end outlet 72, the pressure loss and heat transfer performance can be balanced to improve the heat transfer performance in an optimal manner. Accordingly, it is possible to stably improve the heating efficiency of the absorption liquid by the reboiler 5A.

In addition, the second turbulence structure portion 86 includes a spiral plate portion 861 that is twisted in a spiral shape to generate a swirling flow in the absorption liquid. Therefore, a swirling flow can be generated in the absorption liquid in the vicinity of the gas-liquid multiphase flow region A3 where large bubbles are present inside the heat transfer tube 7 and where the proportion of the gas phase is the highest. Therefore, in the vicinity of the gas-liquid multiphase flow region A3 close to the upper end outlet 72, the heat transfer performance can be improved while suppressing an increase in pressure loss. In particular, when the reboiler 5A is operated under high load with a large flow rate of the absorption liquid flowing inside the heat transfer tube 7, the heat transfer performance can be improved more significantly while suppressing an increase in pressure loss. Accordingly, it is possible to more efficiently improve the heating efficiency of the absorption liquid by the reboiler 5A.

The first turbulence structure portion 85 and the second turbulence structure portion 86 are connected by a rod-shaped connecting portion 87. The connecting portion 87 is formed in a rod shape, so that it does not cause any change in the flow of the absorption liquid. Therefore, in the heat transfer enhancement device 8A, the connecting portion 87 functionally separates the first turbulence structure portion 85 that generates turbulence and the second turbulence structure portion 86 that generates a swirling flow in the vertical direction Dv. Therefore, different flows can be effectively generated in the absorption liquid in each of the first turbulence structure portion 85 and the second turbulence structure portion 86. Accordingly, it is possible to more efficiently structure the heating efficiency of the absorption liquid by the reboiler 5A.

### Third Embodiment

Next, a reboiler 5B according to a third embodiment of the present disclosure will be described. In the third embodiment described below, configurations common to the first embodiment and the second embodiment are given the same reference numerals in the drawings and descriptions thereof will be omitted. In the third embodiment, the structure of a heat transfer tube 7B is different from the structure in the first embodiment.

In the reboiler 5B of the third embodiment, the cross section of the heat transfer tube 7B is different to change in the vertical direction Dv. The heat transfer tube 7B of the third embodiment is a spiral-shaped tube material twisted from a downward position Dvd to an upward position Dvu in the vertical direction Dv. The heat transfer tube 7B has an inner peripheral surface formed in a spiral shape to generate a swirling flow in the absorption liquid flowing inside the heat transfer tube 7B. Accordingly, the internal flow passage cross section of the heat transfer tube 7B changes in the vertical direction Dv to repeatedly increase and decrease.

### Operation and Effect

In the reboiler 5B of the third embodiment, the heat transfer tubes 7 and 7B are formed as spiral-shaped tube materials such that the cross section of the heat transfer tubes 7B changes in the vertical direction Dv. Therefore, the flow of the absorption liquid can be disturbed not only by the heat transfer enhancement devices 8 but also by the heat transfer tubes 7B. Accordingly, it is possible to further improve the heating efficiency of the absorption liquid by the reboiler 5B.

In particular, in the present embodiment, the heat transfer tube 7B is formed in a spiral shape, and therefore, a swirling flow can be generated in the absorption liquid by the inner peripheral surface of the heat transfer tube 7B. Therefore, regardless of the structure of the heat transfer enhancement devices 8, in the vicinity of the gas-liquid multiphase flow region A3, the heat transfer performance can be improved while suppressing an increase in pressure loss.

### Other Embodiments

While preferred embodiments of the invention have been described and illustrated above, it should be understood that these are exemplary examples of the invention and are not to be considered as limiting. Additions, omissions, substitutions, and other modifications can be made without departing from the scope of the invention. Accordingly, the invention is not to be considered as being limited by the foregoing description and is only limited by the scope of the appended claims.

In addition, the reboilers 5, 5A, and 5B are not limited to a structure in which they are directly connected to the regeneration tower 3 in the carbon dioxide recovery system 1. For example, the reboilers 5, 5A, and 5B may be disposed in an absorption liquid circulation line in which a filtration device that removes impurities from the absorption liquid and a reclaiming device that performs a reclaiming process to remove degraded materials and the like that have accumulated in the absorption liquid under high temperatures are disposed.

Further, the reboilers 5, 5A, and 5B are not limited to being disposed in the carbon dioxide recovery system 1. The reboilers 5, 5A, and 5B may be disposed in a power generation system such as a gas turbine that burns fossil fuels, a cement manufacturing system, an iron and steel manufacturing system, a waste energy recovery system, a gas engine system, or a chemical plant.

Furthermore, the shape of the heat transfer enhancement devices 8 and 8A is not limited. The heat transfer enhancement devices 8 and 8A may be disposed inside the heat transfer tubes 7 and 7B and may generate turbulence in the absorption liquid.

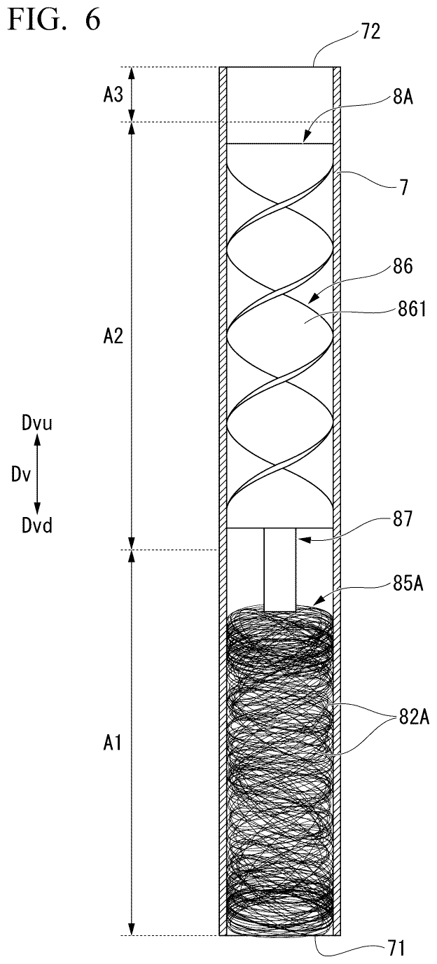

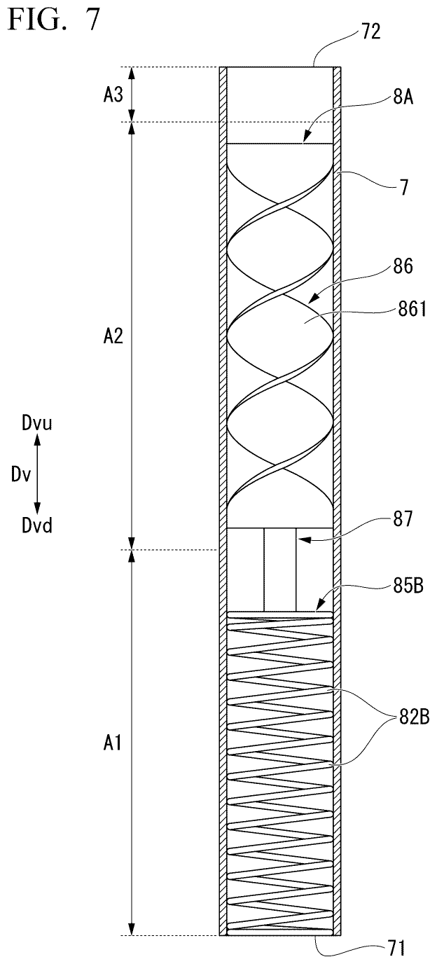

Furthermore, the heat transfer enhancement devices 8 and 8A are not limited to a structure having the shaft core portion 81. The heat transfer enhancement devices 8 and 8A may have any structure as long as they are capable of generating turbulence. Therefore, the turbulence forming portion 82 and the first turbulence structure portion 85 are not limited to the structures in the above-described embodiments. For example, as shown in FIG. 6, the first turbulence structure portion 85A may not include a shaft core portion 81, but may include a turbulence forming portion 82A having a steel wool-like structure in which very fine and flexible iron fibers are randomly disposed. Also, for example, as shown in FIG. 7, a first turbulence structure portion 85B may not include a shaft core portion 81, but may include a turbulence forming portion 82B which has a coil-like structure in which wire-like members are disposed to form a single spiral.

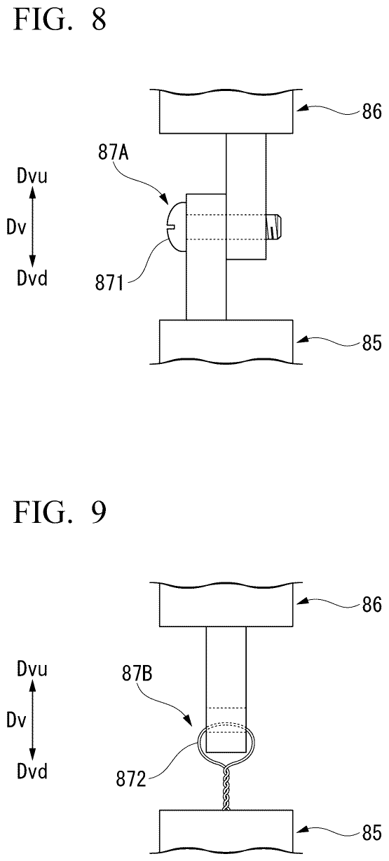

Furthermore, the connecting portion 87 is not limited to the structure in which it is integrally formed with the shaft core portion 81 and has the same diameter as that of the second embodiment. The connecting portion 87 may have any structure as long as it connects the first turbulence structure portion 85 and the second turbulence structure portion 86. Therefore, a connecting portion 87A may have a structure in which the first turbulence structure portion 85 and the second turbulence structure portion 86 are fixed together by a rivet 871 as shown in FIG. 8. Furthermore, as shown in FIG. 9, a connecting portion 87B may have a structure in which the first turbulence structure portion 85 and the second turbulence structure portion 86 are fixed together by a wire 872.

### Supplementary Note

The reboilers 5, 5A, and 5B and the acid gas recovery system described in each embodiment can be understood, for example, as follows.

(1) A reboiler 5, 5A, or 5B according to a first aspect is a reboiler 5, 5A, or 5B that heats an absorption liquid containing water and an amine supplied from an acid gas recovery device, the reboiler 5, 5A, or 5B including: a casing 6 extending in a vertical direction Dv and forming a heat medium space therein to which a heat medium, which configured to raise a temperature of the absorption liquid, is supplied; a heat transfer tube 7 or 7B extending in the vertical direction Dv, disposed inside the casing 6 to pass through the heat medium space and through which the absorption liquid is flowable; and a heat transfer enhancement device 8 or 8A disposed inside the heat transfer tube 7 or 7B, extending in the vertical direction Dv, and generating turbulence in the flowing absorption liquid through the heat transfer tube 7 or 7B, in which the heat transfer tube 7 or 7B has a lower end inlet 71 which is a lower end of the heat transfer tube 7 or 7B in the vertical direction Dv and through which the absorption liquid in a liquid phase state is introduced, and an upper end outlet 72 which is an upper end of the heat transfer tube 7 or 7B in the vertical direction Dv and through which the absorption liquid in a gas-liquid two-phase state is discharged, and the heat transfer enhancement device 8 or 8A extends upward Dvu from the lower end inlet 71 to a position spaced downward Dvd from the upper end outlet 72 in the vertical direction Dv.

With such a configuration, heat exchange occurs between the heat medium supplied to the heat medium space inside the casing 6 and the absorption liquid flowing inside the heat transfer tube 7 or 7B, thereby heating the absorption liquid. Inside the heat transfer tube 7 or 7B, the absorption liquid flowing in from the lower end inlet 71 comes into contact with the heat transfer enhancement device 8 or 8A and generates turbulence, while flowing toward the upper end outlet 72. The heat transfer enhancement device 8 or 8A generates turbulence in the absorption liquid, thereby promoting heat transfer and improving the heating efficiency of the absorption liquid. In particular, by extending the heat transfer enhancement device 8 or 8A from the lower end inlet 71, the pressure loss occurring in the absorption liquid that has just flowed into the heat transfer tube 7 or 7B can be increased. This allows the absorption liquid flowing in from the lower end inlet 71 to be agitated and uniformly supplied toward the upper end outlet 72. Furthermore, the heat transfer enhancement device 8 or 8A extends in the vertical direction Dv from the lower end inlet 71 to a position spaced downward Dvd from the upper end outlet 72 through which the absorption liquid in a gas-liquid two-phase state is discharged. At the upper end outlet 72 from which the absorption liquid in a gas-liquid two-phase state is discharged, large bubbles are present. If large bubbles come into contact with the heat transfer enhancement device 8 or 8A, the increase in heat transfer performance relative to an increase in pressure loss is reduced. However, the heat transfer enhancement device 8 or 8A is located away from the upper end outlet 72 where the absorption liquid in a gas-liquid two-phase state containing large bubbles is present. As a result, the pressure loss caused by the heat transfer enhancement device 8 or 8A can be suppressed, and the heat transfer performance can be further improved. Accordingly, it is possible to improve the heating efficiency of the absorption liquid by the reboiler 5, 5A, or 5B.

(2) A reboiler 5, 5A, or 5B according to a second aspect is the reboiler 5, 5A, or 5B described in (1), in which a space inside the heat transfer tube 7 or 7B forms a preheating region A1 formed at a position facing the lower end inlet 71 and configured to preheat the absorption liquid, a bubble flow region A2 located at an upward position Dvu in the vertical direction Dv with respect to the preheating region A1 and in which bubbles are generated by vaporizing a part of the absorption liquid, and a gas-liquid multiphase flow region A3 formed at a position facing the upper end outlet 72 and in which a gas-liquid interface is disturbed and a flow in a state where a gas and a liquid are mixed together is generated, in which the heat transfer enhancement device 8 or 8A extends to be disposed only in the preheating region A1 and the bubble flow region A2 among the preheating region A1, the bubble flow region A2, and the gas-liquid multiphase flow region A3.

With such a configuration, the heat transfer enhancement device 8 or 8A is not disposed in the gas-liquid multiphase flow region A3 inside the heat transfer tube 7 or 7B where large bubbles are present and the proportion of gas phase is the highest. By disposing the heat transfer enhancement device 8 or 8A inside the heat transfer tube 7 or 7B, avoiding the gas-liquid multiphase flow region A3 which has the highest gas phase proportion, it is possible to precisely reduce pressure loss due to the heat transfer enhancement device 8 or 8A while further improving heat transfer performance. Accordingly, it is possible to improve the heating efficiency of the absorption liquid by the reboiler 5, 5A, or 5B with high precision.

(3) A reboiler 5A according to a third aspect is the reboiler 5, 5A, or 5B described in (1) or (2), in which the heat transfer enhancement device 8A includes a first turbulence structure portion 85 that changes a flow of the absorption liquid into a turbulent state, and a second turbulence structure portion 86 that is disposed at an upward position Dvu in the vertical direction Dv with respect to the first turbulence structure portion 85 and is formed in a shape different from a shape of the first turbulence structure portion 85 to change the flow of the absorption liquid into a turbulent state different from a turbulent state of the first turbulence structure portion 85.

With such a configuration, inside the heat transfer tube 7 or 7B, the absorption liquid flows to reach the second turbulence structure portion 86 after the flow is disturbed in the first turbulence structure portion 85. Accordingly, in the region close to the lower end inlet 71, the flow is disturbed by the first turbulence structure portion 85, and in the region close to the upper end outlet 72, the flow is disturbed by the second turbulence structure portion 86. Therefore, even if the state of the absorption liquid differs between the region close to the lower end inlet 71 and the region close to the upper end outlet 72, the pressure loss and heat transfer performance can be balanced to improve the heat transfer performance in an optimal manner. Accordingly, it is possible to stably improve the heating efficiency of the absorption liquid by the reboiler 5A.

(4) A reboiler 5A according to a fourth aspect is the reboiler 5A described in (3), in which the second turbulence structure portion 86 includes a spiral plate portion 861 that formed by twisting in a spiral shape to generate a swirling flow in the absorption liquid.

With such a configuration, a swirling flow can be generated in the absorption liquid in the vicinity of the large bubbles present inside the heat transfer tube 7 or 7B. Therefore, in the vicinity of the upper end outlet 72, the heat transfer performance can be improved while suppressing an increase in pressure loss. Accordingly, it is possible to more efficiently improve the heating efficiency of the absorption liquid by the reboiler 5A

(5) A reboiler 5A according to a fifth aspect is the reboiler 5, 5A, or 5B described in (3) or (4), in which the heat transfer enhancement device 8A further includes a connecting portion 87 extending in the vertical direction Dv, the connecting portion connecting the first turbulence structure portion 85 and the second turbulence structure portion 86 in the vertical direction Dv.

With such a configuration, the connecting portion 87 is formed in a rod shape, so that it does not cause any change in the flow of the absorption liquid. Therefore, in the heat transfer enhancement device 8A, the connecting portion 87 functionally separates the first turbulence structure portion 85 and the second turbulence structure portion 86 in the vertical direction Dv. Therefore, different flows can be effectively generated in the absorption liquid in each of the first turbulence structure portion 85 and the second turbulence structure portion 86. Accordingly, it is possible to more efficiently structure the heating efficiency of the absorption liquid by the reboiler 5A.

(6) A reboiler 5B according to a sixth aspect is the reboiler 5, 5A, or 5B described in any one of (1) to (5), in which a cross section of the heat transfer tube 7B is different to change in the vertical direction Dv.

With such a configuration, the flow of the absorption liquid can be disturbed not only by the heat transfer enhancement device 8 or 8A but also by the heat transfer tube 7B. Accordingly, it is possible to further improve the heating efficiency of the absorption liquid by the reboiler 5B.

(7) An acid gas recovery system according to a seventh aspect includes: an absorption tower 2 that brings a target gas of treatment containing an acid gas into contact with an absorption liquid containing water and an amine and discharges the absorption liquid having absorbed the acid gas and an absorption tower exhaust gas containing the target gas of treatment from which the acid gas has been removed; a regeneration tower 3 that dissipates the acid gas from the absorption liquid discharged from the absorption tower 2 and discharges the absorption liquid from which the acid gas has been dissipated and a regeneration tower exhaust gas containing the acid gas; and the reboiler 5, 5A, or 5B described in any one of (1) to (5), in which the reboiler 5, 5A, or 5B is supplied with the absorption liquid in the regeneration tower 3, which is the acid gas recovery device.

With such a configuration, the absorption liquid supplied from the regeneration tower 3 is heated. Therefore, the absorption liquid circulating between the regeneration tower 3 and the absorption tower 2 can be efficiently heated to dissipate the acid gas.

### EXPLANATION OF REFERENCES

1 Carbon dioxide recovery system
2 Absorption tower
11 Target gas of treatment line
12 Absorption tower discharge line
3 Regeneration tower
13 Rich line
35 Rich pump
14 Lean line
37 Lean pump
4 Absorption liquid heat exchanger
15 Regeneration tower discharge line
5, 5A, 5B Reboiler
6 Casing
7, 7B Heat transfer tube
A1 Preheating region
A2 Bubble flow region
A3 Gas-liquid multiphase flow region
71 Lower end inlet
72 Upper end outlet
8, 8A Heat transfer enhancement device
81 Shaft core portion
82 Turbulence forming portion
85, 85A, 85B First turbulence structure portion
86 Second turbulence structure portion
861 Spiral plate portion
87, 87A, 87B Connecting portion
Dv Vertical direction
Dvu Upward
Dvd Downward

1. A reboiler that heats an absorption liquid containing water and an amine supplied from an acid gas recovery device, the reboiler comprising:
a casing extending in a vertical direction and forming a heat medium space therein to which a heat medium, which configured to raise a temperature of the absorption liquid, is supplied;
a heat transfer tube extending in the vertical direction, disposed inside the casing to pass through the heat medium space, and through which the absorption liquid is flowable; and
a heat transfer enhancement device disposed inside the heat transfer tube, extending in the vertical direction, and generating turbulence in the flowing absorption liquid through the heat transfer tube,
wherein the heat transfer tube has a lower end inlet which is a lower end of the heat transfer tube in the vertical direction and through which the absorption liquid in a liquid phase state is introduced, and an upper end outlet which is an upper end of the heat transfer tube in the vertical direction and through which the absorption liquid in a gas-liquid two-phase state is discharged, and
the heat transfer enhancement device extends upward from the lower end inlet to a position spaced downward from the upper end outlet in the vertical direction.

2. The reboiler according to claim 1,
wherein a space inside the heat transfer tube forms
a preheating region formed at a position facing the lower end inlet and configured to preheat the absorption liquid,
a bubble flow region located at an upward position in the vertical direction with respect to the preheating region and in which bubbles are generated by vaporizing a part of the absorption liquid, and
a gas-liquid multiphase flow region formed at a position facing the upper end outlet and in which a gas-liquid interface is disturbed and a flow in a state where a gas and a liquid are mixed together is generated, and
the heat transfer enhancement device extends to be disposed only in the preheating region and the bubble flow region among the preheating region, the bubble flow region, and the gas-liquid multiphase flow region.

3. The reboiler according to claim 1,
wherein the heat transfer enhancement device includes
a first turbulence structure portion that changes a flow of the absorption liquid into a turbulent state, and
a second turbulence structure portion that is disposed at an upward position in the vertical direction with respect to the first turbulence structure portion, and is formed in a shape different from a shape of the first turbulence structure portion to change the flow of the absorption liquid into a turbulent state different from a turbulent state of the first turbulence structure portion.

4. The reboiler according to claim 3,
wherein the second turbulence structure portion includes a spiral plate portion that formed by twisting in a spiral shape to generate a swirling flow in the absorption liquid.

5. The reboiler according to claim 3,
wherein the heat transfer enhancement device further includes a connecting portion extending in the vertical direction, the connecting portion connecting the first turbulence structure portion and the second turbulence structure portion in the vertical direction.

6. The reboiler according to claim 1,
wherein a cross section of the heat transfer tube is different to change in the vertical direction.

7. An acid gas recovery system comprising:
an absorption tower that brings a target gas of treatment containing an acid gas into contact with an absorption liquid containing water and an amine and discharges the absorption liquid having absorbed the acid gas and an absorption tower exhaust gas containing the target gas of treatment from which the acid gas has been removed;
a regeneration tower that dissipates the acid gas from the absorption liquid discharged from the absorption tower and discharges the absorption liquid from which the acid gas has been dissipated and a regeneration tower exhaust gas containing the acid gas; and
the reboiler according to claim 1,
wherein the reboiler is supplied with the absorption liquid in the regeneration tower, which is the acid gas recovery device.
